(19) United States
(12) Patent Application Publication
(10) Pub. No.: US 2026/0048578 A1
(43) Pub. Date: Feb. 19, 2026

(54) Electron Beam (EB) Curing of Inks and In-Situ Crosslinking of Substrates to Provide Sustainable and Recyclable Flexible Packaging Solutions

(71) Applicant: Energy Sciences Inc., Wilmington, MA (US)

(72) Inventors: Imtiaz Rangwalla, Andover, MA (US); Brian Sullivan, Lawrence, MA (US)

(21) Appl. No.: 19/369,697

(22) Filed: Oct. 27, 2025

Related U.S. Application Data
(62) Division of application No. 16/973,110.
(60) Provisional application No. 62/873,868, filed on Jul. 13, 2019.

(51) Int. Cl. B32B 38/00; B32B 7/12; B32B 27/08; B32B 27/32; B41J 2/447

(52) U.S. Cl. CPC B32B 38/0008; B32B 7/12; B32B 27/08; B32B 27/32; B32B 38/145; B41J 2/4476; B32B 2250/03; B32B 2250/242; B32B 2255/10; B32B 2255/26; B32B 2307/518; B32B 2307/732; B32B 2439/46; B32B 2439/70; B32B 2439/80

(57) ABSTRACT

A recyclable flexible multi-layer packaging film used for foods, non-foods, pharmaceuticals, and other products that would benefit from flexible packaging solutions is provided. The present invention also relates to the methods of forming recyclable flexible packaging using fewer production steps while using EB curable inks & EB laminates, among others.

### RELATED APPLICATIONS

This application is a divisional application of U.S. application Ser. No. 16/973,110, filed on Jul. 6, 2020, which is the U.S. National Stage of International Application No. PCT/US2020/040858, filed Jul. 6, 2020, which designates the U.S., published in English, and claims the benefit of U.S. Provisional Application No. 62/873,868, filed Jul. 13, 2019. The entire teachings of the above applications are incorporated herein by reference.

### FIELD OF INVENTION

The present invention relates generally to sustainable and recyclable flexible packaging, and more particularly to electron beam (EB) curing of inks and oriented polyethylene based flexible packaging for food and non-food applications.

### BACKGROUND

Flexible packaging has long been used for food, non-food, and pharmaceutical applications, and may extend beyond these areas for other uses. Plastic films, paper and metalized films are used in various combinations to make laminates that are then used to form different types of packaging depending on the types and conditions of use required. Flexible packaging is economical and utilizes a lower carbon footprint as compared to rigid packaging. This trend is driving consumers and companies to move more aggressively towards the use of flexible packaging that is recyclable.

Rigid packaging includes packaging made from metals, glass and rigid plastics, e.g., bottles and cans, some of which are not recyclable. As a result, the flexible packaging industry is growing faster than other packaging segments. A recent FPA (Flexible Packaging Association) report disclosed that revenues in North America for 2017 were $31.0 billion. The global market for flexible packaging is close to $100 billion, with a growth of 4-5% annually with Asia showing the largest growth rate.

Polymer based multi-layer flexible packaging is popular these days because this approach provides a combined performance of the different polymers used to manufacture these products. The multi-layered polymer flexible packaging products are popular because the combination of several layers of different materials improves the mechanical and physical properties of the packaging film, e.g., improving heat and moisture resistance, oxygen barrier properties, antibacterial and antiviral properties, puncture or tear resistance, etc. Multi-layer flexible packaging products and their method of formation have been described in, e.g., PCT/US2017/068881 (Bemis).

These properties have improved the packaged product quality and shelf life, thereby encouraging the big players in the field to move towards flexible multi-layered packaging. At the same time there is a global urgency to creating more recyclable products and materials. Unfortunately, the existing technologies are frequently not recyclable, or otherwise difficult and expensive to recycle. As a consequence of this poor recyclability, these multi-layered packaging materials create mostly unwanted non-biodegradable waste.

Another global emerging issue is the increased awareness of plastics in our landfills, oceans and rivers, and the resulting demands to reduce our global carbon footprint. Companies like P&G and Unilever are feeling pressure to have sustainable packaging mandates that include reduced packaging, reduced carbon footprints, and recyclable materials. The EB curing of inks and lacquers for packaging have been discussed in U.S. Pat. Nos. 6,528,127, 7,063,882, 6,772,683, and 8,729,147, for example, and provide teachings of inks having low to zero volatile organic compounds (VOCs), which can help to reduce the carbon footprint by almost 3×. The above patents and application (U.S. Pat. Nos. 6,528,127, 7,063,882, 6,772,683, 8,729,147, and PCT/US2017/068881 (Bemis)) are incorporated by reference.

The materials used in most of the currently available flexible packaging structures are not considered readily recyclable because of the presence of two or more dissimilar films or layer materials used to manufacture the final package. For packaging to be considered recyclable, the top film and the subsequent layers/films, including for example a laminated film (e.g., sealant film), must be of the same or similar material and be e-beam cross-linkable. By way of example only, polyethylene packaging containing the same or similar materials can be pelletized and recycled. Provided that the above-noted material requirements are followed, many other frequently used materials in flexible packaging can be made recyclable.

The Applicant has sought to address some of the above problems as discussed in detail below.

### SUMMARY

According to an embodiment of the present invention, there is provided a flexible package product that is fully functional for the purpose of packaging food and non-food items, results in substantial efficiencies in production and material costs, and is recyclable.

According to another embodiment of the present invention, there is provided a recyclable flexible package with: (i) an Electron Beam (EB) treated oriented, cross-linked polyethylene (OPE) film; (ii) at least one reverse printed EB ink layer; (iii) a laminating layer; and (iv) a sealant polyethylene film.

According to yet another embodiment of the present invention, there is provided a recyclable flexible package with: (i) an Electron Beam (EB) treated oriented, cross-linked polyethylene (OPE) film; (ii) at least one reverse printed EB ink layer; (iii) a laminating EB layer; and (iv) a sealant polyethylene film.

According to yet another embodiment of the present invention, there is provided a recyclable flexible package with: (i) an Electron Beam (EB) treated oriented, cross-linked polyethylene (OPE) film; (ii) a reverse printed EB ink layer disposed over the EB treated OPE film; (iii) a laminating layer disposed over the at least one reverse printed EB ink layer; and (iv) a sealant polyethylene film disposed over the laminating layer.

According to yet another embodiment of the present invention, the EB treated OPE film has a thickness in the range of 20 microns to 40 microns.

According to yet another embodiment of the present invention, the EB treated OPE film is selected from the group: high density polyethylene, medium density polyethylene, low density polyethylene, linear low density polyethylene, and/or combinations thereof.

According to yet another embodiment of the present invention the EB treated OPE film is Machine direction oriented (MDO) or biaxially oriented.

According to yet another embodiment of the present invention the EB treated OPE film is a blown film.

According to yet another embodiment of the present invention the OPE film is made of several layers, the layers consisting of HDPE\MDPE\MDPE\LLDPE\LDPE or combinations involving all or some of the above layers.

According to another embodiment of the present invention the OPE film contains copolymers of polyethylene and ethylene vinyl acetate.

According to another embodiment of the present invention the OPE film contains additives, such as a liquid or master batch from the family of acrylates or methacrylate esters, to reduce the EB dose required to crosslink.

According to another embodiment of the present invention, the at least one reverse printed EB ink layer has a thickness in the range of 1.5 microns to 5 microns.

According to another embodiment of the present invention, the laminating layer has a thickness in the range of 1.5 microns to 2 microns.

According to yet another embodiment of the present invention, the sealant polyethylene film has a thickness in the range of 40 microns to 80 microns.

According to yet another embodiment of the present invention the sealant film is multi- or single layered.

According to another embodiment of the present invention the sealant film includes a barrier layer, for example EVOH coextruded in the layer(s) of the film, or does not include a barrier layer.

According to yet another embodiment the sealant film is biaxially oriented PE film.

According to another embodiment the sealant film contains a barrier layer of SiOₓ or AlOₓ.

According to another embodiment of the present invention, the laminating layer is replaced by a laminating EB layer.

According to another embodiment of the present invention, a method is provided to form a recyclable flexible package, the method involving applying at least one reverse printed Electron Beam (EB) ink layer to an EB treated oriented polyethylene (OPE) film; curing the at least one reverse printed EB ink layer and the EB treated OPE film by electron beam radiation, to cause the OPE film to become cross-linked; and laminating a sealant polyethylene film to the at least one reverse printed EB ink layer by use of a laminating layer between the reverse printed EB ink layer and the sealant polyethylene film, to form the recyclable flexible package.

According to yet another embodiment of the present invention, wherein the steps of applying the at least one reverse printed EB ink layer to the EB treated OPE film, curing the at least one reverse printed EB ink layer and the EB treated OPE film, and laminating a sealant polyethylene film to the at least one reverse printed EB ink layer are performed in two distinct steps.

According to another embodiment of the present invention, the at least one reverse printed EB ink layer, the EB treated OPE film, the laminating EB layer, and the sealant polyethylene film are cured in one step, causing the OPE to become cross-linked.

According to yet another embodiment of the present invention, there is provided an environmentally friendly efficient process to make recyclable flexible packaging with a reduced number of production/operation steps required when using EB inks & EB laminates.

According to another embodiment of the present invention, there is provided a process of making recyclable flexible packaging with the benefits of quicker production times, elimination of long storage times, excessive storage costs, and long-term curing issues during production.

### BRIEF DESCRIPTION OF THE DRAWINGS

FIG. 1 illustrates a cross sectional view of a recyclable flexible package 100 according to an embodiment of the invention.

FIG. 2 illustrates a cross sectional view of the recyclable flexible package 200 according to another embodiment of the invention.

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

### DETAILED DESCRIPTION

A description of example embodiments follows.

Aspects of the present invention are best understood by reference to the description set forth herein. All the aspects described herein will be better appreciated and understood when considered in conjunction with the following descriptions. It should be understood, however, that the following descriptions, while indicating preferred aspects and numerous specific details thereof, are given by way of illustration only and should not be treated as limitations. Changes and modifications may be made within the scope herein without departing from the spirit and scope thereof, and the present invention herein includes all such modifications.

Several aspects of the present invention are disclosed herein. It is to be understood that these aspects may or may not overlap with one another. Thus, part of one aspect may fall within the scope of another aspect, and vice versa. Each aspect is illustrated by a number of embodiments, each of which in turn, can include one or more specific embodiments. It is to be understood that the embodiments may or may not overlap with each other. Thus, part of one embodiment, or specific embodiments thereof, may or may not fall within the ambit of another, or specific embodiments thereof, and vice versa.

A broad framework of the principles will be presented by describing various embodiments of this invention using exemplary aspects. The terms “one embodiment” or “an embodiment” means that a particular feature, structure, material, or characteristic described in connection with the embodiment is included in at least one embodiment of the disclosure. For clarity and ease of description, each aspect includes only a few embodiments. Different embodiments from different aspects may be combined or practiced separately, to design a customized process or product depending upon application requirements. Many different combinations and sub-combinations of a few representative processes or structures shown within the broad framework of this invention, that may be apparent to those skilled in the art but not explicitly shown or described, should not be construed as precluded.

This disclosure is generally directed to products and methods describing a “recyclable flexible package”, Electron beam (EB) curing of inks and in-situ crosslinking of substrates to provide sustainable and recyclable flexible packaging solutions for food and non-food applications.

### Definitions

Reference to “layer(s)” or “film(s)” as used herein refers to a structure of a single polymer type or a blend of polymers.

Reference to “substrate” as used herein refers to a base material on which processing is conducted to produce new films or layers of material such as deposited coatings. In the present invention a “substrate” is selected from polyethylene polymer materials.

Reference to “EB” as used herein refers to a process that involves using electrons, usually of high energy, to treat an object for the purpose of cross-linking and/or curing.

Reference to “polyethylene” as used herein refers to a polymer of ethylene (or ethene) monomer having a structural formula-(CH₂—CH₂—)ₙ. Polyethylene is described as a lightweight, durable thermoplastic with a variable crystalline structure. It is a linear, homo-polymer, which has a partially amorphous phase and partially crystalline phase. The amorphous phase imparts flexibility and high impact strength while the crystalline phase imparts a high softening temperature and rigidity. Therefore, it is primarily used for packaging (plastic bags, plastic films, geomembranes, containers including bottles, etc.).

Reference to “crosslinking” or “cross-linked” as used herein refers to any covalent bonds or ionic bonds that links one polymeric chain to another. Crosslinking usually refers to promoting a change in the physical properties of the polymer.

Reference to a “laminating layer,” as used herein refers to a material placed on one or more layers, partially or entirely, to promote the adhesion of one layer to another surface. A laminating layer may comprise an adhesive composition. Preferably, such layers or coatings of an adhesive composition that are positioned between two layers of a multilayer flexible package are used to maintain the two layers in position relative to each other. Optionally, a laminating layer or an adhesive layer may comprise components that can be cured by UV/EB radiations to improve the functionality and utility of the laminating layer to provide a desired level of adhesion with one or more surfaces in contact with the laminating layer material.

Reference to a “sealant polyethylene film” as used herein refers to one that binds to itself or another film or layer to form a hermetic seal. That is, the sealant polyethylene film comprises a polyethylene polymer or polymer mixture that softens when exposed to heat and returns to its original condition when cooled to room temperature. Instead of polyethylene, the sealant layer may comprise any suitable thermoplastic material including, but not limited to, synthetic polymers such as polyesters, polyamides, polyolefins, polystyrenes, and the like. Thermoplastic materials may also include any synthetic polymers that are cross-linked by either radiation or chemical reaction during a manufacturing or post-manufacturing process operation.

As noted above, the current market for flexible packaging for food and non-food items, e.g., detergent, shampoo pouches, etc., uses different polymers as the substrates in the packaging. These materials are predominantly polyester (PET) and oriented polypropylene (OPP). Each of these materials are used to provide heat resistance during sealing operations, with sealing temperatures as high as approximately 150-200 C. While polyethylene is widely used in most packaging articles, untreated polyethylene (i.e., not EB treated beforehand) used in place of PET or OPP would melt during the heat-sealing step and stick to the sealing jaws, thus making the process ineffective and unworkable. Any resulting pouch or packaging would not pass any quality assurance assessments, and potentially could not even be made.

Applicant discovered that using EB irradiated (oriented) polyethylene (OPE) in place of OPP and/or PET would address these problems noted above and solve the problem of making flexible packaging that is recyclable.

Polymeric films that are oriented and irradiatively cross-linked by EB show improved properties with respect to heat resistance, clarity, and shrinkage as compared to films of the same compositions that are not oriented and irradiatively cross-linked.

Table 1 below compares the properties of Irradiated OPE with non-irradiated OPE. Irradiated OPE is deemed comparable to OPP and PET regarding the relevant properties required necessary for certain operations such as heat sealing processes noted above.

TABLE 1

| | Irradiated OPE | Non irradiated OPE |
|---|---|---|
| Specific gravity gm/cc | 0.916 | 0.916 |
| Tensile strength psi at 22 C. | 8000-16000 | 1500-3000 |
| Tensile strength psi at 93 C. | 1500-3000 | 100-200 |
| % Elongation | 100-200 | 600 |
| Heat seal range C. | 150-300 | 110-150 |
| % Shrinkage 98 C. | 80 | 60 |

Ref. U.S. Pat. No. 3,022,543 Baird et al. 1963

According to an embodiment, the present invention provides a recyclable flexible package having (i) an Electron Beam (EB) treated oriented, cross-linked polyethylene (OPE) film; (ii) at least one reverse printed EB ink layer, (iii) a laminating layer; and (iv) a sealant polyethylene film.

The EB treated oriented, cross-linked polyethylene (OPE) film is a layer of EB irradiated polyethylene polymer. It may be a monolayer or multi-layered film which includes a polyethylene-based polymer or a combination of one or more types of the polyethylene-based polymers. Polyethylene based polymers are frequently categorized based upon their densities, for example high density polyethylene (HDPE), Medium-density polyethylene (MDPE), low density polyethylene” (LDPE) and Linear Low Density Polyethylene (LLDPE). The OPE films described herein may consist of polyethylene homopolymers of one or more densities.

High density polyethylene (HDPE) is ordinarily used in the art to refer to both a.) homopolymers and b.) copolymers of ethylene and an α-olefin (usually 1-butene or 1-hexene) with densities between about 0.960 to 0.970 g/cm³ for homopolymer and between 0.940 and 0.958 g/cm³ for copolymers. HDPE includes polymers made with Ziegler or Phillips type catalysts and is also said to include high molecular weight “polyethylenes.”

Medium-density polyethylene (MDPE) typically has a density from 0.928 to 0.940 g/cm³. MDPE can be produced by chromium/silica catalysts, Ziegler-Natta catalysts or metallocene catalysts.

Low density polyethylene (LDPE) is another type of a high pressure low density polyethylene polymer. It is defined by a density range between 0.915 and 0.940 g/cm³.

Linear Low Density Polyethylene (LLDPE) is structurally similar to LDPE, but it has a linear backbone having a density range from 0.915 to 0.940 g/cm³. It is made by copolymerizing ethylene with 1-butene and smaller amounts of 1-hexene and 1-octene, using Ziegler-Natta or metallocene catalysts.

In one exemplary embodiment of the invention, the OPE film is a monolayer of a HDPE. In another exemplary embodiment, the OPE film is multilayer laminate, preferably a combination of at least a HDPE and a MDPE. In another embodiment, the OPE film is multilayered laminate having the following design: HDPE/MDPE/HDPE. In another embodiment, the multilayered laminate of OPE film has the following design: HDPE-mLLDPE/MDPE/HDPE-LLDPE.

The fabrication of the EB treated OPE film is done by various methods. In one embodiment, a monolayer of OPE film may be formed by extruding resins of a polyethylene through a die, followed by machine direction orientation (MDO) of the film. In another embodiment, a multilayered OPE film may be formed by co-extruding two or more sources of resins of a Polyethylene or of a blend of polyethylenes through two or more individual dies, followed by machine direction orientation (MDO) of the film. To perform the crosslinking throughout the OPE film, the OPE film is exposed to electron beam radiations to form the EB treated OPE film.

The EB treated OPE film has a thickness in the range of 20 microns to 40 microns. In certain instances, it may be desirable to only partially crosslink the OPE for special flexible packaging solutions required by customers that does not affect the quality of the final recyclable products.

In another embodiment, the reverse printed EB ink layer of the recyclable flexible package contains an ink composition with reduced/or no volatile organic compounds. The ink composition contains a polymer and a combination of liquids mainly consisting of radiation curable monomers and/or oligomers, diluents, colorants, additives, photoinitiators, and optionally small amounts of non-reactive solvent and an organic gellant. The above compounds of the ink composition are combined to make a gel system. In an embodiment, the radiation curable monomers and/or oligomers form polymer chain networks, due to reduced amounts of solvent in the composition which result in the formation of an ink gel composition. The reverse printed ink layer is cured under electron beam radiation before applying it on the OPE film to make a reverse printed EB ink layer. The reverse printed EB ink layer may contain one or more ink layers to make a final EB cured ink layer. The reverse printed EB ink layer of the invention provides maximum color strength and has good adhesive properties when applied to the EB treated OPE film.

The reverse printed EB ink layer of the recyclable flexible package has a thickness in the range of 1.5 microns to 5 microns.

In one embodiment, the reverse printed EB ink layer may be cured on either side of the EB treated OPE film of the recyclable flexible package.

The laminating layer of the recyclable flexible package comprises an adhesive which is a thermoplastic polymer selected from the group consisting of copolymers of olefins and (meth-) acrylic acid or derivatives thereof, copolymers of olefins and vinylic compounds, polyolefins, preferably polyethylene, copolymer of ethylene and α-olefins, polyesters, polyamides, thermoplastic synthetic rubber, metallocene-catalyzed polymers, polyurethane, ionomers and combination of two or more of these thermoplastic polymers.

In one embodiment the laminating layer comprises a solvent free adhesive, preferably a polyurethane adhesive system having a density of 9.5 lbs/gallon, a viscosity in the range of 2,500-3,500 cPs, and curing times of 3 days at 77° F. In one exemplary embodiment, the polyurethane adhesives are liquid. In another exemplary embodiment, the polyurethane adhesives are hot melt adhesives.

EB curing of adhesive laminates offers several advantages to the packaging market such as instantaneous bond creation and ultra-fast cure speeds, and offers converters a quick turnaround time for the laminated products. Additional benefits include stable formulations, reduced or zero volatiles, easy to clean systems and suitable curing systems, all of which make EB cured laminates more appropriate for commercial use.

In another embodiment of the present invention, the recyclable package contains a laminating EB layer having a thickness in the range of 1.5 microns to 2 microns.

The sealant polyethylene film of the recyclable flexible package contains a layer of polyethylene polymer to form a multilayered flexible package that is recyclable. The sealant polyethylene film of the present invention has a thickness in the range of 40 microns to 80 microns.

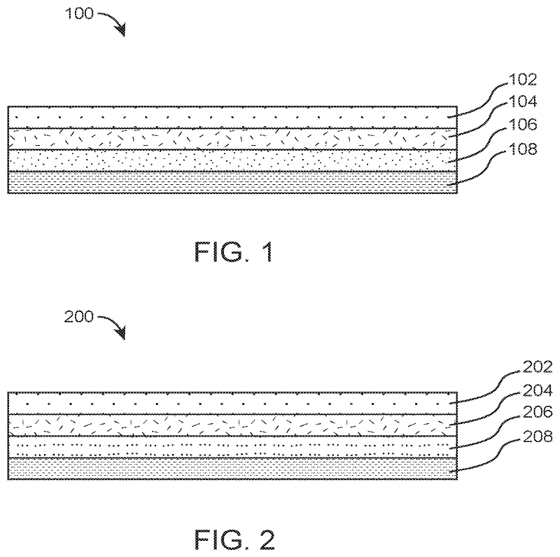

FIG. 1 shows a cross-sectional view of the recyclable flexible package 100 according to one embodiment of the invention. The recyclable flexible package 100 comprises an Electron Beam (EB) treated, oriented cross-linked polyethylene (OPE) film 102, at least one reverse printed EB ink layer 104 disposed over said EB treated OPE film 102, a laminating layer 106 disposed over said at least one reverse printed EB ink layer 104, and a sealant polyethylene film 108 disposed over said laminating layer 106.

FIG. 2 shows the cross-sectional view of the recyclable flexible package 200 according to another embodiment of the invention. The recyclable flexible package 200 comprises an Electron Beam (EB) treated oriented cross-linked polyethylene (OPE) film 202, at least one reverse printed EB ink layer 204 disposed over the EB treated OPE film 202, a laminating EB layer 206 which is used to laminate the sealant polyethylene film 208 onto the at least one reverse printed EB ink layer 204 while disposed between the at least one reverse printed EB ink layer 204 and the sealant polyethylene film 208.

The present invention provides a method of forming a recyclable flexible package, wherein the method includes applying at least one reverse printed EB ink layer to an EB treated oriented polyethylene (OPE) film by extrusion or any other known method of making a multilayered flexible package. After the application of at least one reverse printed EB ink layer to the EB treated oriented polyethylene (OPE) film, both the reverse printed EB ink layer and the EB treated OPE film are then exposed to electron beam radiation for curing the at least one reverse printed EB ink layer and to cause crosslinking in the EB treated OPE film. The voltage of the electron beam radiation is adjusted to allow electron penetration over the full EB treated OPE film thickness ranging from 20 microns to 40 microns. In one embodiment, the radiation by E-beam (EB) is applied at about 2 to about 24 MRad, and all values in that range.

In another embodiment, the method according to the present invention comprises the lamination of the sealant polyethylene film having a thickness in the range of 40 microns to 80 microns, to the at least one reverse printed EB ink layer by use of a laminating layer between the reverse printed EB ink layer and the sealant polyethylene film, to form the recyclable flexible package.

In another embodiment of the invention, the lamination of the sealant polyethylene film to the at least one reverse printed EB ink layer is done by extrusion lamination. The sealant polyethylene film is extruded from a flat die and laminated onto the at least one reverse printed EB ink layer using a laminating layer being applied between the sealant polyethylene film and the at least one reverse printed EB ink layer. The laminating layer in the method can be selected from, but not limited to, an adhesive which is a thermoplastic polymer selected from the group consisting of copolymers of olefins and (meth-) acrylic acid or derivatives thereof, copolymers of olefins and vinylic compounds, polyolefins, preferably polyethylene, copolymer of ethylene and α-olefins, polyesters, polyamides, thermoplastic synthetic rubber, metallocene-catalysed polymers, polyurethane, ionomers and combination of two or more of these thermoplastic polymers.

In another embodiment, the method of forming the recyclable flexible package includes two steps. The first step includes applying the at least one reverse printed EB ink layer to the EB treated OPE film and simultaneously curing the at least one reverse printed EB ink layer and the EB treated OPE film by electron beam radiation, causing the OPE film to become cross-linked. The second step includes laminating the sealant polyethylene film to the at least one reverse printed EB ink layer and EB treated OPE film obtained from the first step. The lamination of the sealant polyethylene is done by using a laminating layer between the reverse printed EB ink layer and the sealant polyethylene film, to form the recyclable flexible package.

In yet another embodiment of the invention, the laminating layer is replaced by a laminating EB layer having a thickness in the range of 1.5 microns to 2 microns.

In yet another embodiment of the invention, the method of forming the recyclable flexible package includes only one step. The method includes curing of the at least one reverse printed EB ink layer, the EB treated OPE film, the laminating EB layer, and the sealant polyethylene film, causing the EB treated OPE film to become cross-linked. The curing step is done by using electron beam radiations, wherein the voltage is controlled to crosslink the EB treated OPE film, cure the reverse printed EB ink layer, and cure the laminating EB layer. The voltage control restricts penetration of the sealant film to prevent problems with downstream processing.

The flexible packaging products are completely recyclable in nature and compliant with existing recycling laws. The processes used to create the finished flexible packaging products having the disclosed structures are more economical and efficient. For example, the processes require substantially less solvent use with reductions ranging from 70% solvents down to about less than 10% solvents. Further, there is no requirement for afterburners or other solvent recovery systems in most situations if at all. Such reductions would likely mean lower material and supply costs, as well as reduced equipment needs.

The foregoing exemplary embodiments are provided for illustrative purposes only and are not intended to limit the scope of the invention.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A recyclable flexible multi-layer film comprising:
an Electron Beam (EB) cross-linkable, oriented polyethylene (OPE) film;
at least one reverse printed EB curable ink layer disposed over the EB cross-linkable, oriented polyethylene (OPE) film;
a laminating layer comprising a thermoplastic adhesive; and
a sealant polyethylene film coupled to the curable ink layer by way of the laminating layer,
wherein the cross-linkable OPE film, curable ink layer, laminating layer, and sealant polyethylene film are coupled together, forming the recyclable flexible multi-layer film.

2. The recyclable flexible multi-layer film according to claim 1, wherein the OPE film has a thickness in the range of 20 microns to 40 microns.

3. The recyclable flexible multi-layer film according to claim 1, wherein the OPE film is selected from the group consisting of high density polyethylene, medium density polyethylene, low density polyethylene, linear low density polyethylene, and/or combinations thereof.

4. The recyclable flexible multi-layer film according to claim 1, wherein the at least one reverse printed EB curable ink layer has a thickness in the range of 1.5 microns to 5 microns.

5. The recyclable flexible multi-layer film according to claim 1, wherein the laminating layer has a thickness in the range of 1.5 microns to 2 microns.

6. The recyclable flexible multi-layer film according to claim 1, wherein the sealant polyethylene film has a thickness in the range of 40 microns to 80 microns.

7. The recyclable flexible multi-layer film of claim 1, wherein the laminating layer is a laminating EB layer.

8. A recyclable flexible multi-layer film consisting of:
an Electron Beam (EB) cross-linkable oriented polyethylene (OPE) film;
a reverse printed EB curable ink layer disposed over the EB cross-linkable OPE film;
a laminating layer disposed over the at least one reverse printed EB cured ink layer; and
a sealant polyethylene film disposed over the laminating layer, less than an entire thickness of the sealant polyethylene film being EB treated coupled to the curable ink layer by way of the laminating layer,
wherein the cross-linkable OPE film, curable ink layer, laminating layer, and sealant polyethylene film are coupled together, forming the recyclable flexible multi-layer film.

9. The recyclable flexible multi-layer firm according to claim 8, wherein the OPE film has a thickness in the range of 20 microns to 40 microns.

10. The recyclable flexible multi-layer film according to claim 8, wherein the OPE film is selected from a group consisting of: high density polyethylene, medium density polyethylene, low density polyethylene, linear low density polyethylene, and/or combinations thereof.

11. The recyclable flexible multi-layer film according to claim 8, wherein the at least one reverse printed EB curable ink layer has a thickness in the range of 1.5 microns to 5 microns.

12. The recyclable flexible multi-layer film according to claim 8, wherein the laminating layer has a thickness in the range of 1.5 microns to 2 microns.

13. The recyclable flexible multi-layer film according to claim 8, wherein the sealant polyethylene film has thickness in the range of 40 microns to 80 microns.

14. The recyclable flexible multi-layer film of claim 8, wherein the laminating layer is a laminating EB layer.
